(19) United States
(12) Patent Application Publication
(10) Pub. No.: US 2013/0168880 A1
(43) Pub. Date: Jul. 4, 2013

(54) ELECTRONIC VAPORIZING DEVICE

(71) Applicant: BRENT DUKE, Chicago, IL (US)

(72) Inventor: BRENT DUKE, Chicago, IL (US)

(21) Appl. No.: 13/495,787

(22) Filed: Jun. 13, 2012

(30) Foreign Application Priority Data
Dec. 30, 2011 (CN) 201120565297.8

(51) Int. Cl. B01D 1/16; B01F 3/04

(52) U.S. Cl. 261/78.2; 261/81; 261/26

(57) ABSTRACT

An electronic vaporizing device that includes an atomizing device connected to an external shell. The external shell has an internal compartment that contains an airflow activated switch; a bottle of liquid; a liquid chamber; a battery; and a circuit board comprising a microchip. A user inhaling through the atomizing device triggers the airflow activated switch which in turn activates the microchip and the battery, causing the atomizing device to guide the liquid through the liquid chamber. The liquid is then vaporized by the atomizing device and can be inhaled by the user.

### CROSS-REFERENCE TO RELATED APPLICATIONS

This application claims the benefit of Chinese Patent Application Serial No. 201120565297.8 filed on Dec. 30, 2011, which application is incorporated herein by reference.

### FIELD

The present system is related to atomizing technology that is utilized in electronic cigarette technology.

### BACKGROUND

It is well known that smoking is harmful to health; however, there are still over 1 billion smokers in the world and smoking causes over 5 million deaths annually.

Due to the addictive quality of nicotine, cigarette use is an extremely difficult habit to curtail. The rapid absorption of nicotine into the blood stream provides the smoker with a positive feeling or high that leads to continued use. This smoke is also known to be a danger to nonsmokers who are simply in the presence of cigarette smoke.

Nicotine itself, while the addictive ingredient in a cigarette, has a very short half-life in human blood in small doses. However, cigarettes also contain numerous carcinogens, which are what cause cigarettes to be dangerous.

The purpose of electronic cigarettes has been to find another way for a smoker to inhale this same nicotine without also inhaling all of the other chemicals in a cigarette. This is similar in concept to the nicotine patch, nicotine gum, or nicotine water. These products, however, do not also satisfy the psychological need for inhaling some type of “smoke”.

This has led to the subsequent emergence of electronic cigarettes through Chinese invention patent applications CN03111173.4, CN03111582.9, and CN200710123347. These devices contain lithium-ion batteries and microchips and atomize nicotine liquid at 50-60 degrees Celsius.

In theory, these devices should eliminate much of the harmful smoke that is found in a traditional cigarette. Tests are currently underway and many tests have been completed that are attempting to prove this hypothesis.

The current electronic cigarette technology can be found in FIG. 1. FIG. 1 illustrates a diagram of an exemplary electronic cigarette device. The device-comprised of an LED light 5, an airflow switch 4, a lithium ion battery 2, an outer casing 6, atomizing device 1, and a microchip 3. A disadvantage of the current device design is that there is a limited lifespan. In a two-piece design, this is usually no more than 1 millimeter of liquid per atomizing device. The current device has no way to visually indicate when there is a shortage of liquid; therefore, a lack of liquid often causes a burning and ruining of atomizing devices. As well, the battery cannot be removed, thus, when the battery dies; the entire device must be replaced. The batteries are usually no more than 280 mA and need to be recharged. A user must always have a charger to charge the battery. Further, liquid also regularly leaks into the battery or microchip causing an immediate malfunction of the device. The current device has no way to visually view the battery charge or forecast the duration of charging of the battery. Moreover, the LED lights in current devices are flimsy, constantly pop off and get lost; such that, consumers must replace the LED light or the entire unit. Additionally, the airflow switches tend to get jammed and this also means that the entire device needs to be replaced.

Thus, there exists a need for electronic atomizing devices or electronic cigarette with a design that has a longer lifespan and allows for interchangeable parts and ease of mass production.

### SUMMARY

The present system is a solution that leverages an innovative design for an electronic vaporizing device. The present invention relates to an electronic vaporizing that comprises an atomizing device connected to an external shell. The external shell comprises an internal compartment, the internal compartment comprising an airflow activated switch; a bottle of liquid; a liquid chamber; a battery; and a circuit board comprising a microchip. A user inhaling through the atomizing device triggers the airflow activated switch which in turn activates the microchip and the battery, causing the atomizing device to guide the liquid through the liquid chamber. The liquid is then vaporized by the atomizing device and can be inhaled by the user. The present invention also comprises an atomizing device that can be screwed into the top of this device. The electronic vaporizing device may comprise a magnetized lid, allowing it to close easily to keep the internal components protected.

The electronic vaporizing device may comprise a transparent window that allows for visualization of the liquid bottle. The electronic vaporizing device also allows for a visual of LED lights which show the remaining charge on the rechargeable battery. The electronic vaporizing device also may comprise a USB charging port on the bottom of the device to allow for simple recharging of the unit.

Inhaling through the atomizing device activates the device which then heats, the liquid, creating a vapor for the user. There are absolutely no buttons to push to activate the device of the present invention; simply inhaling triggers the switch which activates that atomizing device.

The electronic vaporizing device of the present invention allows for much easier use and a longer lifespan than any other non-tobacco nicotine delivery system on the market today. The electronic vaporizing device of the present invention also allows for interchangeable parts and ease of mass production.

### BRIEF DESCRIPTION OF THE FIGURES

The accompanying drawings, which are included as part of the present specification, illustrate the presently preferred embodiment and, together with the general description given above and the detailed description of the preferred embodiment given below, serve to explain and teach the principles of the present invention.

FIG. 1 is a diagram of an exemplary current electronic cigarette device.

FIG. 2 is a diagram of an exemplary electronic vaporizing device, according to one embodiment of the present invention.

FIG. 3 is a perspective view of an exemplary electronic vaporizing device, according to one embodiment of the present invention.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

The electronic vaporizing device of present invention provides an easy-to-use simple structure that would overcome the listed shortcomings of the existing technology. The device of present invention solves the issues of the existing technology. The present invention is a “modified” electronic cigarette that has absolutely no buttons and is suitable for large scale mass production.

The electronic vaporizing device of the present invention comprises an airflow switch, a bottle of liquid, an atomizing device, a microchip, and a battery all inside an elliptical cylinder-shaped shell. In order for the liquid to reach the atomizing device there is a liquid chamber where the liquid remains until it is vaporized by the atomizing device. The outer shell snaps off of the internal parts of the device, which provides easy access for battery or liquid replacement and maintenance.

The shell also has a transparent window which allows the user to view the levels of liquid in the bottle. In any previous version of an electronic cigarette, the user has been restricted to one color. With this version we changed that, as the shell snaps right off, and a different colored shell can easily be used.

The battery indicator can be seen through the outer shell, indicating the power level of the rechargeable battery.

The atomizing device screws into the unit. The entire device along with the atomizing device is contained in the lid, which adds a layer of protection to the atomizing device.

The present electronic vaporizing device includes the case, the atomizing device, the airflow switch, circuit board, battery, bottle for liquid, and a liquid chamber. The airflow switch activates the battery and the microchip in the circuit board. The atomizing device then vaporizes the liquid in the chamber. As the user is inhaling, liquid from the bottle is being drawn into the atomizing device, automatically refilling it. In one embodiment, the present invention comprises an electronic cigarette.

The battery is both rechargeable and replaceable. The bottle of liquid can be refilled an unlimited number of times.

The transparent window in the shell allows a real-time liquid status. Since the liquid is visible, the user will know when to replace the liquid, which will keep the atomizing device from overheating.

There is also a real-time battery power indicator. This can be seen through the cover. The cover includes a lid which offers protection for the atomizing device from dirt, dust, and general wear and tear.

This device also includes a USB charging port. This means that while the rechargeable battery can be recharged outside of the device, it can also be charged inside the device.

The design is a sleek elliptical cylinder, fitting perfectly in a pocket and differentiating itself from all other electronic cigarettes.

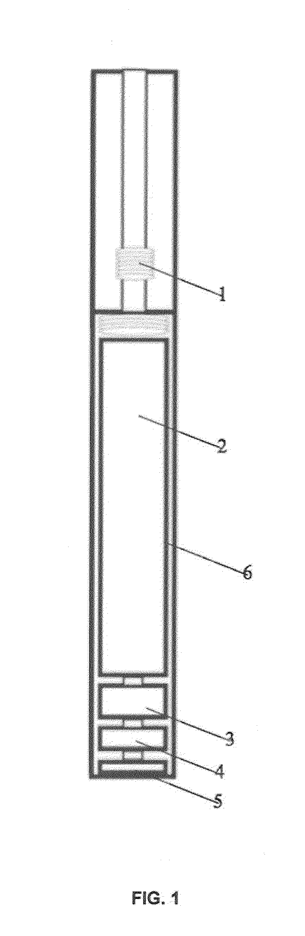

FIG. 1 illustrates a diagram of an exemplary current electronic cigarette device. The device comprised of an LED light 5, an airflow switch 4, a lithium ion battery 2, an outer casing 6, atomizing device 1, and a microchip 3. Virtually all mass-produced electronic cigarettes are similar in shape, size, and functionality to this design. The flaws of the current design were outlined in the background above.

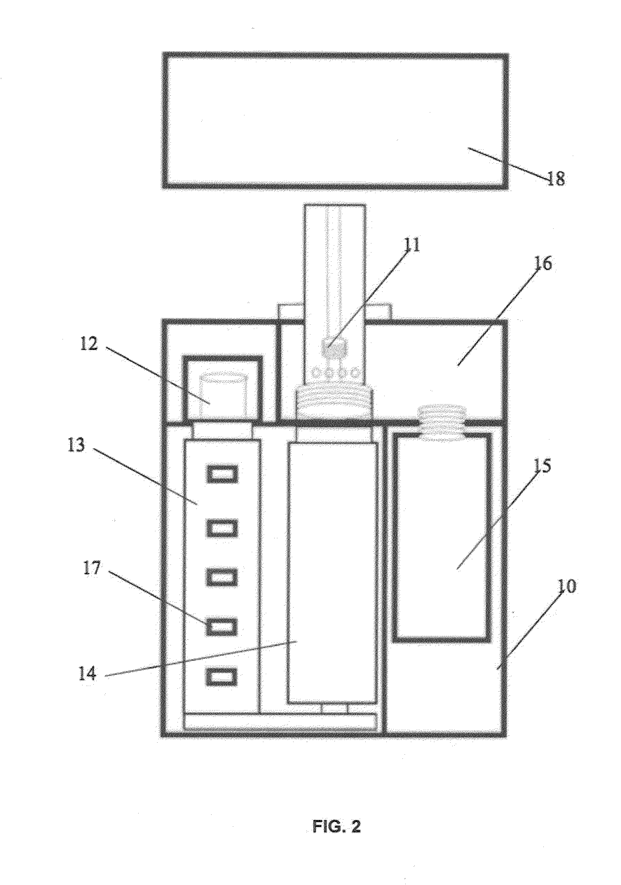

FIG. 2 illustrates a diagram of an exemplary electronic vaporizing device, according to one embodiment of the present invention. This includes the shell (10), circuit board containing microchips (13), battery (14), bottle for liquid (15), liquid chamber (16), and airflow switch (12). The microchip controls the device and is activated by the airflow switch. The microchip turns on the battery. All of the components described are set inside the shell.

The atomizing device (11) connects to the shell and vaporizes the liquid. The liquid reaches the atomizing device from the liquid chamber. The liquid first travels from the liquid bottle to the liquid chamber.

The battery and the bottle of liquid can both be removed from the shell. The shell easily snaps off, providing access to the internal components.

The shell has a transparent window, which is not shown. This provides a visual as to the level of liquid in the bottle.

The battery indicator unit (17) lights up and is visible through the shell and indicates the power level of the battery. The circuit board (13) contains a microchip, resistors, capacitors, LEDs (or LCD screen), and a micro USB charging port. All of these components are contained inside an internal cover. This can be viewed as the entire shell has a transparent coating that allows sight of internal lighting. The battery indicator may be installed in any suitable location. The current location in the device is visible in the diagram. This battery indicator can be made of any suitable components, including but not limited to LEDs or an LCD screen. LED lights can have different colors or numbers of lights. LCD screens could show power indication levels through actual numbers or through any other suitable method.

In order to protect the atomizing device, this device also includes a lid (18). The lid has a magnetized connection to the device, ensuring that lid remains in place.

For convenience of charging the battery, there is a USB charging connection (not shown) on the bottom of the device.

While the shell can be any non-traditional cigarette shape, in this diagram and in this present invention the device is an elliptical cylinder.

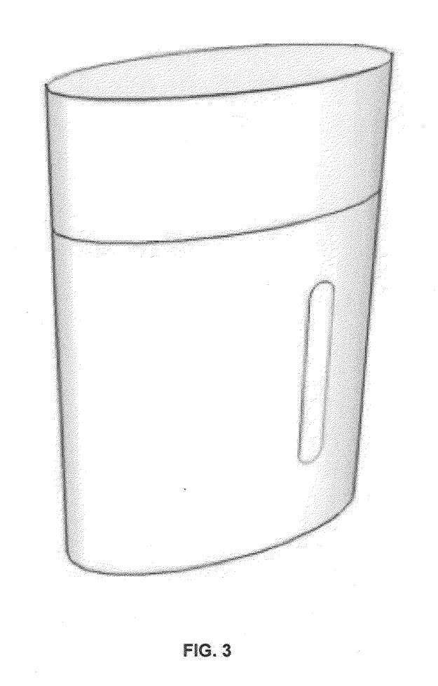

While the bottle in this device currently carries a nicotine (or non-nicotine) propylene glycol and/or vegetable glycerin based solution, any vaporizable liquid can be used in this bottle, as shown in FIG. 3. FIG. 3 is a perspective view of an exemplary electronic vaporizing device, according to one embodiment of the present invention. The design is a sleek elliptical cylinder, fitting perfectly in a pocket and differentiating itself from all other electronic cigarettes. To use the device, remove the lid, inhale through the atomizing device which triggers the airflow switch. The circuit board controls the atomizing device, causing it to heat up the liquid that sits in the liquid chamber. Simultaneously, the battery indicator lights up to allow the user to immediately view the battery power remaining in the battery.

In summary, this is the first non-traditional tobacco cigarette shaped product which has a succinct design suitable for large scale production. Various modifications and transformations without departure from the original utility of the device will be necessary and should be protected under this application. Hence, the descriptions and drawings should be considered illustrative rather than restrictive.

In the description above, for purposes of explanation only, specific nomenclature is set forth to provide a thorough understanding of the present disclosure. However, it will be apparent to one skilled in the art that these specific details are not required to practice the teachings of the present disclosure.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

We claim:

1. An electronic vaporizing device comprising:
an atomizing device connected to an external shell, wherein the external shell comprises an internal compartment, the internal compartment comprising:
an airflow activated switch;
a bottle of liquid;
a liquid chamber;
a battery; and
a circuit board comprising a microchip;
wherein a user inhaling through the atomizing device triggers the airflow activated switch which in turn activates the microchip and the battery, causing the atomizing, device to guide the liquid through the liquid chamber; and
wherein the liquid is vaporized by the atomizing device and can be inhaled by the user.

2. The electronic vaporizing device of claim 1, wherein the external shell is an elliptical cylinder shape.

3. The electronic vaporizing device of claim 2, wherein the external shell comprises a lid.

4. The electronic vaporizing device of claim 3, wherein the lid is a magnetized lid.

5. The electronic vaporizing device of claim 2, wherein the atomizing device fits inside the lid of the external shell.

6. The electronic vaporizing device of claim 5, wherein the atomizing device is accessed by lifting the lid off the external shell.

7. The electronic vaporizing device of claim 1, wherein the external shell can be removed completely to allow access to the internal compartment.

8. The electronic vaporizing device of claim 1, wherein the external shell comprises a transparent window allowing for visual display of the level of liquid comprised in the bottle of liquid.

9. The electronic vaporizing device of claim 1, further comprising a battery indicator.

10. The electronic vaporizing device of claim 9, wherein the external shell allows for a visual display of the battery indicator.

11. The electronic vaporizing device of claim 9, wherein battery indicator is controlled by the microchip.

12. The electronic vaporizing device of claim 9, wherein battery indicator comprises a LCD screen technology.

13. The electronic vaporizing device of claim 9, wherein battery indicator comprises LED lights which show the current power indication level.

14. The electronic vaporizing device of claim of 1, wherein the battery is a rechargeable battery.

15. The electronic vaporizing device of claim of 14, further comprising a USB charging device that establishes connections with the rechargeable battery.

16. The electronic vaporizing device of claim of 1, wherein the liquid can be vaporized in the bottle within the external shell of the electronic vaporizing device.
